(19) United States
(12) Patent Application Publication
(10) Pub. No.: US 2006/0032351 A1
(43) Pub. Date: Feb. 16, 2006

(54) Methods and apparatus for cutting tubing

(76) Inventors: John J. Scinta, Plainview, NY (US); Mark W. Scinta, Brewster, NY (US)

Correspondence Address: DAVIS & ASSOCIATES, P.O. BOX 1093, DRIPPING SPRINGS, TX, 78620, US

(21) Appl. No.: 10/918,051

(22) Filed: Aug. 13, 2004

(51) Int. Cl. B26D 1/30

(52) U.S. Cl. 83/54; 83/603

(57) ABSTRACT

A tubing cutter includes a cutter head assembly apparatus having first and second jaws coupled to permit adjusting a jaw span. A lever arm carrying a blade is pivotably coupled to the first jaw. A spring applies a spring force to the lever arm for biasing the blade towards the second jaw.

### BACKGROUND OF THE INVENTION

1. Field of the Invention

The present invention describes methods and apparatus for cutting tubing.

2. Description of the Related Art

In the housing and construction industry, piping and tubing are frequently used in systems designed to transport and regulate the delivery of fluid, particularly water. The piping and tubing are typically concealed within walls or attics of the structure, thereby hiding the tubing systems from the view of the occupants. As such, those repairing or changing plumbing are often forced to cut open an existing wall, crawl into an attic, or even bore a hole into a concrete slab to access a tube or pipe requiring service.

One type of manual tubing cutter requires the entire apparatus to be rotated about the tube being cut. This approach requires sufficient clearance about the entire perimeter of the tube to accommodate the cutter. Such clearance is frequently not available in the examples presented above.

One disadvantage of some handheld automated cutters is that the cutter heads are complex. Attempts to increase the cutting force typically result in larger cutter heads that may render the tool inappropriate in limited access environments. Smaller cutter heads tend to provide reduced cutting forces so that a substantially greater number of rotations of the cutting head is required. The increased number of rotations undesirably increases the time required to sever the tube. Reduced cutting forces lead to shallower cuts for each rotation. Maintaining the position of the cutter can be difficult, at least initially, when the cutter is capable only of making shallow cuts.

### SUMMARY OF THE INVENTION

A tubing cutter includes a cutter head assembly apparatus having first and second jaws coupled to permit adjusting a jaw span. A lever arm carrying a blade is pivotably coupled to the first jaw. A spring applies a spring force to the lever arm for biasing the blade towards the second jaw.

In one embodiment a circuit for illuminating a blade contact area is provided. In one embodiment an alignment circuit is provided to permit aligning the cutter head assembly to an alignment position for receiving the tube.

Still other features and advantages of the present invention will become evident to those of ordinary skill in the art in light of the following. Also, one should understand that the scope of this invention is intended to be broad, and any combination of any subset of the features, elements, or steps described herein is part of the intended scope of the invention.

### BRIEF DESCRIPTION OF THE DRAWINGS

FIG. 1 provides a perspective view of one embodiment of a tubing cutter.

FIG. 2 provides an exploded view of one embodiment of the tubing cutter illustrating a drive train.

FIG. 3 provides an exploded view of a right and left casing according to one embodiment of the tubing cutter.

FIG. 4 provides a perspective view with the left casing removed to illustrate one embodiment of a drive train assembly.

FIG. 5 provides a perspective view of one embodiment of a cutter head assembly.

FIG. 6 provides an exploded view of the cutter head assembly.

FIG. 7 provides an exploded view of one embodiment of a center block assembly.

FIG. 8 provides an exploded rear perspective view of one embodiment of a jaw span adjustment device.

FIG. 9 provides an exploded view of one embodiment of an upper jaw assembly.

FIG. 10 illustrates a tube located within the jaw assembly.

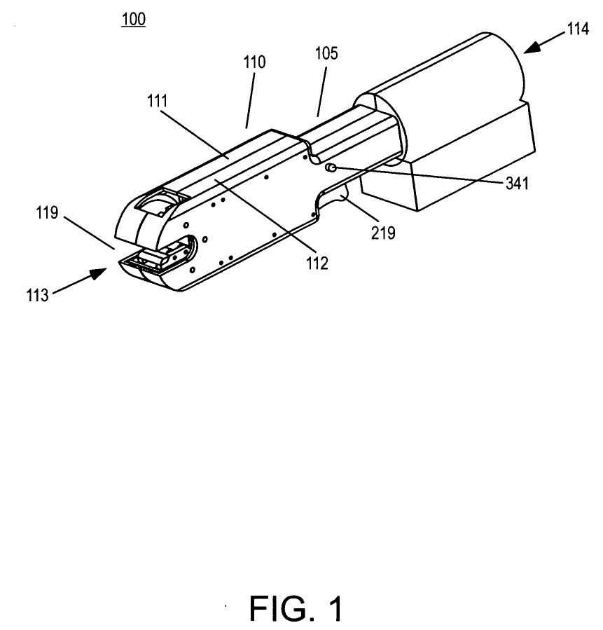

FIG. 1I A illustrates one embodiment of a lighting and alignment circuit.

FIG. 1I B illustrates positioning of a magnet associated with the alignment circuit.

FIG. 12 illustrates one embodiment of a method for adjusting the tubing cutter jaw span.

FIG. 13 illustrates one embodiment of a method for aligning a cutter head assembly with a passage of the tubing cutter.

FIG. 14 illustrates one embodiment of a method for cutting tubing.

### DETAILED DESCRIPTION

As required, detailed embodiments of the present invention are disclosed herein; however, it is to be understood that the disclosed embodiments are merely exemplary of the invention, which may be embodied in various forms. It is further to be understood that the figures are not necessarily to scale, and some features may be exaggerated to show details of particular components or steps.

A tubing cutter provides the ability to cut tubing in restricted areas, as well as unrestricted areas. The tubing cutter includes a rotating cutter head that rotates about an axis of a tube being sectioned. The cutter head assembly is activated by an operator, such that power from a power supply energizes a driver to rotate an input shaft of a drive train. An output of the drive train engages the cutter head assembly, thereby rotating the cutter head assembly. The cutter head assembly includes an adjustable set of jaws to accommodate various tubing sizes, telescoping pins to minimize a vertical height, and a cutting wheel disposed on a lever arm. The lever arm is energized by at least one spring plate, such that the cutting wheel is pressed against the tube being sectioned, and rotated around the tube when the driver is energized. Further embodiments of the tubing cutter include a light source and an aligning circuit to aid the operator during use.

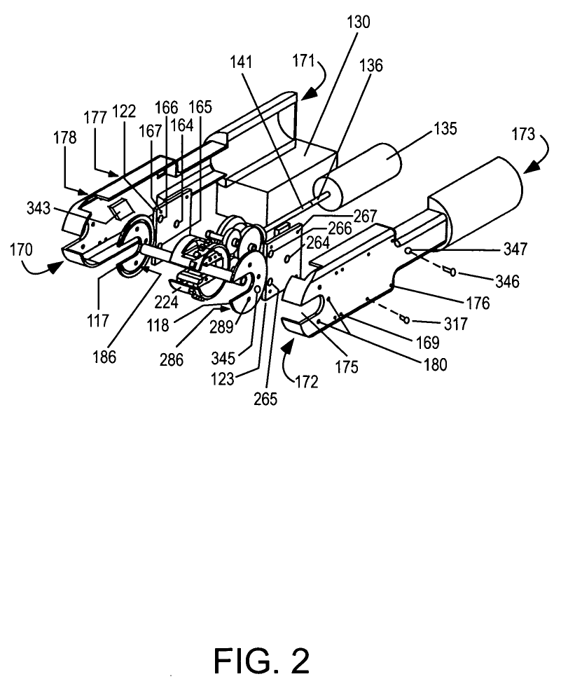

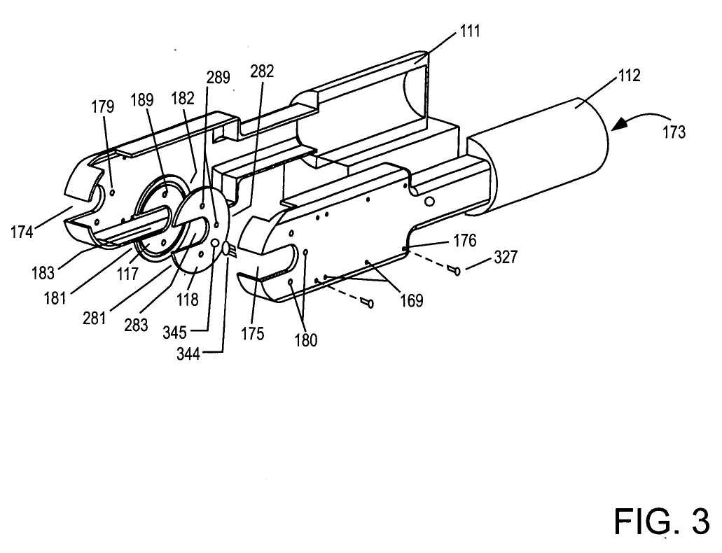

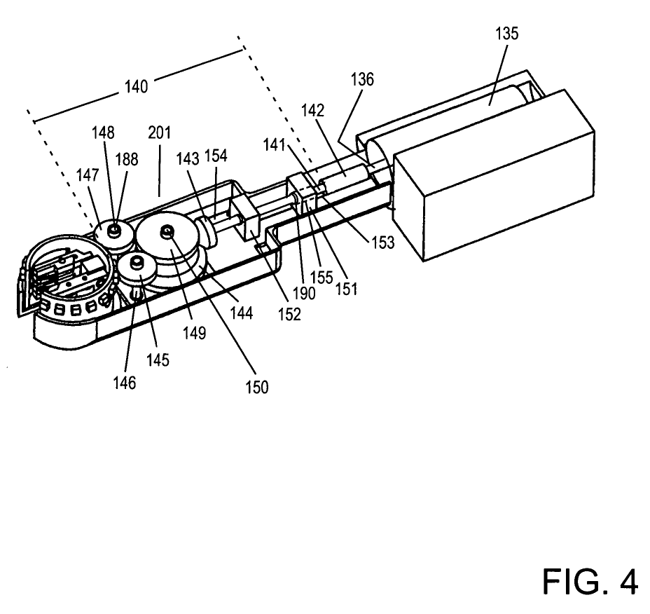

As shown in FIGS. 1 and 2, a tubing cutter 100 includes a housing 110 having a first end 113 and a second end 114, a drive train assembly 140, a power supply 130, and a cutter head assembly 120. The housing 110 includes a right casing 111, a left casing 112, a right traction plate 117, a left traction plate 118, a right bearing plate 122 and a left bearing plate 123. The housing 110 further includes a passage 119 through the first end 113. The passage 119 is of a size at least as great as a largest outer diameter of a maximum tube cut size, preferably slightly larger. The housing 110 further includes a handle 105, such that an operator can wrap a hand around the tubing cutter 100 during use. The handle 105 is a reduced width section of the right casing 111 and the left casing 112. As shown in FIG. 3, the right casing 111 includes a first end 170, a second end 171, and the reduced width section passing through the handle 105. The left casing 112 also includes a first end 172 and a second end 173. The passage 119 passes through the first ends 170 and 172 of the right and left casings 111 and 112, substantially centered thereon. The right casing 111 further includes bearing mount apertures 177, casing restraint apertures 178, and traction plate apertures 179.

The left casing 112 is substantially a mirror image of the right casing 111, and includes bearing plate restraint apertures 169, casing restraint apertures 176, and traction plate restraint apertures 180. The left casing 112 further includes a button aperture 347 on an outer side of the handle 105 portion, and provisions for restraining a switch 341 disposed interior to the handle 105. First switch 341 is accessible through the button aperture 347. The right and left casings 111 and 112 may be fastened together to close out open areas and form the major structural component of the housing 110. The right and left casings 111 and 112 further include cutouts 174 and 175, and rounded corners 162 on the first ends 170 and 172 to minimize obstruction due to the housing 110. The right casing 111 and the left casing 112 may be of any suitable material that has acceptable rigidity and strength properties, for example, metals, such as aluminum, or some injection molded plastics including ABS.

The first end 170 of the right casing 111 further includes provisions for mounting a second switch 343 adjacent to the right traction plate 117. The second ends 171 and 173 of the right and left casings 111 and 112 may be adaptable to a driver 135, or in an injection molded configuration, may be contoured to surround the driver 135. The driver 135 may be mounted to right and left casings 111 and 112 using any suitable means, including screws, restraint brackets, or capturing between two mating components. Preferably, the driver 135 is located within the confines of the housing 110, thereby minimizing the risk of injury due to contact moving parts. Locating the driver 135 at the second end 114 of the housing 110 aids in balancing the tubing cutter 100 when held at the handle 105 by an operator. In this configuration, the tubing cutter 100 is operable with one hand, but may also be operated with two hands. In this preferred embodiment, the driver 135 is an electric motor with a gearbox. The driver 135 further includes an output shaft 136. One of ordinary skill in the art will recognize that virtually any form of torque transmission device may be coupled to an input shaft 141 of the drive train assembly 140 to produce the desired result.

The second end 114 of the housing 110 may further include provisions for mounting the power supply 130. As such, the second ends 171 and 173 of the right and left casings 111 and 112, respectively, may be adaptable to the power supply 130. The power supply 130 may be any suitable power storage device, including various forms of batteries. Further extensions of this embodiment may include a removable battery pack, a rechargeable battery pack, or the like. While this embodiment has been shown with a battery, it should be clear to one of ordinary skill in the art that an alternating current source may be utilized to power an alternating current driver.

The right traction plate 117 is a cylindrical section having a first end 181 and a second end 182. A diameter of the right traction plate 117 is slightly smaller than a width of the right casing 111. The circular shape minimizes obstruction and provides increased accessibility during use. The right traction plate 117 includes a cutout 183, a groove 186, and mounting apertures 189. The cutout 183 is substantially the same shape and form as the passage 119, and is centered on the first end 181. The groove 186 is of a sufficient width and depth to allow a guide tube 224 of the cutter head assembly 120 to fit into the groove 186, and allow the guide tube 224 to rotate while in the groove 186. The right traction plate 117 is mountable to the first end 170 of the right casing 111, such that the passage 119 and the cutout 183 align, and the mounting apertures 189 of the right traction plate 117 align with the apertures 179 of the right casing 111.

The left traction plate 118 is substantially a mirror image of the right traction plate 117, however, the left traction plate 118 further includes a light aperture 345. The left traction plate 118 further includes a first end 281 and a second end 282. The first end 281 includes a cutout 283 centered thereon. The left traction plate 118 further includes a groove 286 and mounting apertures 289. The light aperture 345 is located near the cutout 283 and within the groove 286. The light aperture 345 is designed to accept a light source 344. The left traction plate 118 is mountable to the first end 172 of the left casing 112, such that the passage 119 and the cutout 283 align, and the mounting apertures 289 of the left traction plate 118 align with the apertures 180 of the left casing 112.

As illustrated in FIG. 2, the right bearing plate 122 is a rectangular plate that positions and restrains the drive train assembly 140 components. The right bearing plate 122 includes a drive gear shaft aperture 164, a first output gear shaft aperture 165, a second output gear shaft aperture 166, and a plurality of mounting apertures 167. The shaft apertures 164, 165, and 166 are of sufficient size to accommodate positioning of a bearing 188. A bearing 188 is disposed within the confines of the shaft apertures 164, 165, and 166, such that shafts from the drive train assembly 140 may be positioned within an inner race of the bearings 188. The mounting apertures 167 provide a means for securing the right bearing plate 122 to the right casing 111.

The left bearing plate 123 is substantially a mirror image of the right bearing plate 122, and includes a drive gear shaft aperture 264, a first output gear shaft aperture 265, a second output gear shaft aperture 266, and a plurality of mounting apertures 267. The shaft apertures 264, 265, and 266 are of sufficient size to accommodate positioning of a bearing 188. A bearing 188 is disposed within the confines of the shaft apertures 264, 265, and 266, such that shafts from the drive train assembly 140 may be positioned within an inner race of the bearings 188. The mounting apertures 267 provide a means for securing the left bearing plate 123 to the left casing 112. The right and left bearing plates 122 and 123 may be constructed from any suitable material, including steel, aluminum, or some plastics.

The drive train assembly 140 is illustrated in FIG. 4, and includes the input shaft 141, a coupler 142, a first bearing mount 151, a second bearing mount 152, a first bevel gear 143, a second bevel gear 144, a drive gear 149, a drive gear shaft 150, a first output gear assembly 205, and a second output gear assembly 210. The input shaft 141 is a cylindrically shaped object that is rigid enough to transmit torque from a first end 153 to a second end 154 with minimal deflection. The input shaft 141 is typically constructed from a metal, for example, a steel or aluminum.

The coupler 142 may be any suitable device for coupling two shafts together, including the use of screws, setscrews, drive pins, and the like to rigidly attach a shaft to the coupler 142, thereby coupling the two attached shafts together. In this preferred embodiment, the coupler 142 joins the output shaft 136 of the driver 135 to the input shaft 141 of the drive train assembly 140.

The first and second bearing mounts 151 and 152 include an aperture 155 of a size suitable for accepting a bearing 190. The bearing 190 may be virtually any type of roller bearing that will support the input shaft 141 and allow the input shaft 141 to rotate without hindrance.

The bearing mounts 151 and 152 are securable to the housing using any suitable means, including screws, adhesives, or passive restraints.

The first bevel gear 143 is a forty-five degree bevel gear. The first bevel gear 143 is secured to the input shaft 141 using any form of securing components, including the use of a setscrew, spline, welded connection, or the like.

A drive gear assembly 201 includes the drive gear shaft 150, the second bevel gear 144, and the drive gear 149. The drive gear shaft 150 is a metallic rod, preferably hardened steel, and is of a size suitable for mating with an inner race of the bearings 188. The length of the shaft 150 is sufficient to reach both bearings installed in the bearing plates 122 and 123.

The second bevel gear 144 is also a forty-five degree bevel gear. The second bevel gear may be secured to the drive gear shaft 150. Examples of securing components include setscrews, drive pins, or splines.

The drive gear 149 is a spur gear with gear teeth disposed on its outer periphery. The drive gear 149 is secured to the drive gear shaft 150 using any suitable means, such that the drive gear 149 and the drive gear shaft 150 turn as a unit around an axis of the drive gear shaft 150. In this preferred embodiment, the drive gear 149 is sized to further reduce the input rate of rotation of the drive train assembly 140.

The first output gear assembly 205 includes a first output gear shaft 146 and a first output gear 145. A plurality of gear teeth are disposed along the outer periphery of the first output gear 145. The gear teeth are of a size and spacing to mate with the gear teeth of the drive gear 149. The first output gear 145 is secured to the first output gear shaft 146. The first output gear shaft 146 is of sufficient length to mate with the bearings 188 disposed in the bearing plates 122 and 123.

The second output gear assembly 210 is identical to the first output gear assembly 205, however, it is located at an alternate angular position relative to the drive gear assembly 201. The second output gear assembly 210 includes a second output gear shaft 148 and a second output gear 147. A plurality of gear teeth are disposed along the outer periphery of the second output gear 147. The second output gear 147 is secured to the second output gear shaft 148.

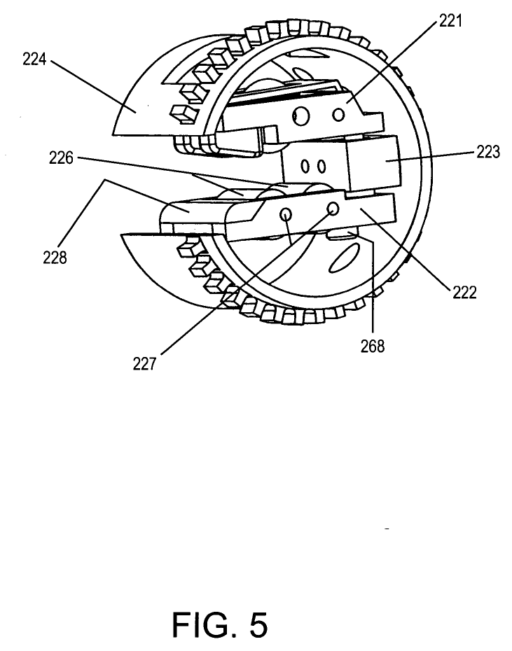

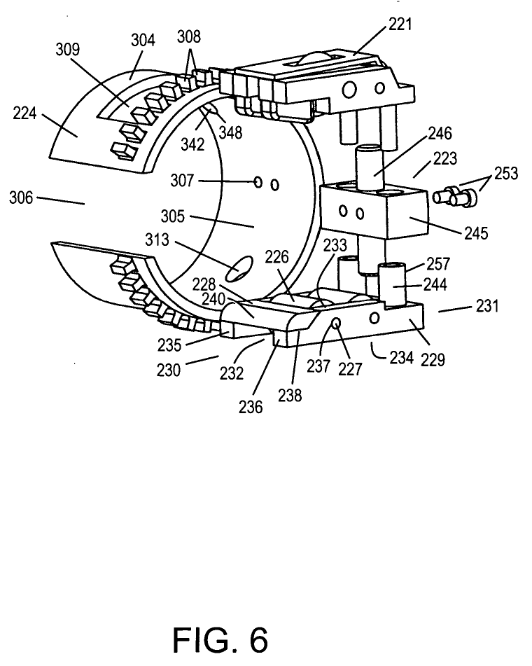

FIG. 5 provides a perspective view of the cutter head assembly 120, and FIG. 6 provides an exploded view of the cutter head assembly 120. The cutter head assembly 120 includes an upper jaw assembly 221, a lower jaw assembly 222, a center block assembly 223, and the guide tube 224. The lower jaw assembly 222 includes a plurality of rollers 226, roller shafts 227, a lower dock 228, and a lower jaw 229. The lower jaw 229 is constructed from metallic plate, and includes a first end 230, a second end 231, a top side 233, and a bottom side 234. The first end 230 includes a rectangular cutout 232 passing from the topside 233 to the bottom side 234 of the lower jaw 229, thereby forming a first arm 235 and a second arm 236. The cutout 232 is of a width slightly greater than the length of rollers 226. The first arm 235 and the second arm 236 include apertures 237 passing through the arms 235 and 236 from the cutout 232 to the outer faces of the first and second arms 235 and 236. The apertures 237 are of a size suitable for receiving the roller shafts 227. The first and second arms 235 and 236 further include a recessed portion 238 for receiving the lower dock 228.

The rollers 226 are cylindrical in shape and include central apertures for receiving the roller shafts 227. The rollers 226 are constructed from a metallic material, preferably stainless or hardened steel. The roller shafts 227 are also cylindrical in shape, and of a size suitable for entering the apertures 237 and the central apertures of the rollers 226.

The lower dock 228 is a rigid component with a large radius 240 on a front edge. The lower dock 228 fits into the recessed portions 238, and joins the extreme ends of the first and second arms 235 and 236. The lower dock 228 is constructed from a plastic having low friction coefficient, preferably, Teflon.

The second end 231 of the lower jaw 229 includes a recessed flat 243, a threaded aperture 241 and a plurality of guide apertures 242. The threaded aperture 241 is centrally located on the recessed flat 243, and passes from the recessed flat 243 to the bottom side 234 of the lower jaw 229. The threaded aperture 241 is threaded with a reverse thread for engagement with a threaded member 246. The guide apertures 242 are disposed on each end of the recessed flat 243, and pass through to the bottom side 234 of the lower jaw 229. Each guide apertures 242 is of a size suitable for engaging a lower guide pin 244.

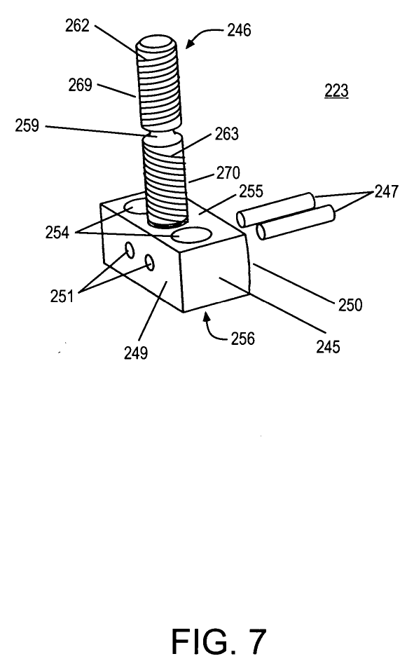

The center block assembly 223, as illustrated in FIG. 7, includes a center block 245, stake pins 247, and the threaded member 246. The center block 245 is rectangular in shape, and includes an inner face 249 and an outer face 250. The outer face 250 is of a shape complementary to an inner periphery 305 of the guide tube 224. The center block 245 includes stake apertures 251 passing from the outer face 250 to the inner face 249. The center block 245 still further includes a plurality of mounting apertures 252. The mounting apertures 252 are threaded to accept mounting screws 253. The center block 245 further includes a plurality of guide apertures 254 disposed along the center block 245, passing from a top side 255 to a bottom side 256. The central guide aperture 254 is of a size suitable for accepting the threaded member 246 without engaging any threads of the threaded member 246. The remaining guide apertures 254 are of a size suitable for engaging an outer diameter 257 of the lower guide pins 244.

The threaded member 246 is cylindrical in shape, and includes a first end 260 and a second end 261. A groove 259 separates the first end 260 and the second end 261. The groove 259 is cylindrical in shape, and of a diameter slightly larger than the stake pin 247. The first end 260 includes threads 262 around an outer periphery 269 that travel in a first direction. The threads 262 of the first end 260 are of a size suitable for mating with a threaded aperture 295 of an upper jaw 272. The second end 261 includes threads 263 around an outer periphery 270 that travel in a second direction. The second end 261 further includes a user interface 268, typically a design that may mate with a screwdriver or other suitable interface tool. The threads 263 of the second end 261 of the threaded member 246 are of a size and spacing complementary to the threaded aperture 241 of the lower jaw 229.

The stake pins 247 are cylindrical in shape, and of a diameter complementary to the stake apertures 251. The stake pins 247 may be spring pins, dowel pins, or the like. The stake pins 247 may be constructed from a metallic material that is suitable for use with the center block material, preferably stainless steel.

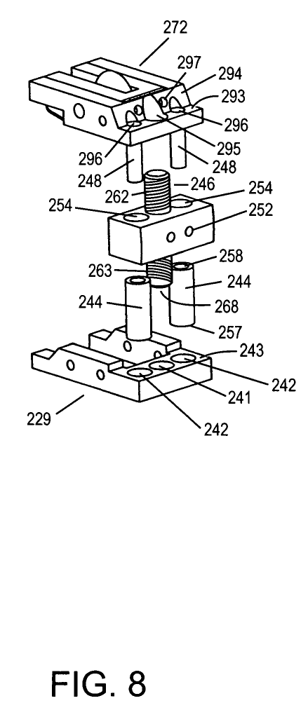

FIG. 8 provides a rear perspective exploded view of the cutter head assembly 120. The lower guide pins 244 are of a hollow cylindrical shape, and include the outer diameter 257 and an inner diameter 258. In this preferred embodiment, the lower guide pins 244 are constructed from any suitable material having increased strength characteristics. The outer diameter 257 is of a size suitable for mating with the guide apertures 242 of the lower jaw 229 and the guide apertures 254 of the center block 245. The inner diameter 258 is complementary to an outer diameter 257 of the upper guide pins 248. The outer diameters 257 and the inner diameter 258 may be polished to reduce the friction coefficient of the material.

The upper guide pins 248 are cylindrical in shape, and are complementary to the guide apertures 296 of the upper jaw 272 as well as the inner diameters 258 of the lower guide pins 244. The upper guide pins 248 may be constructed from a similar material used to construct the lower guide pins 244.

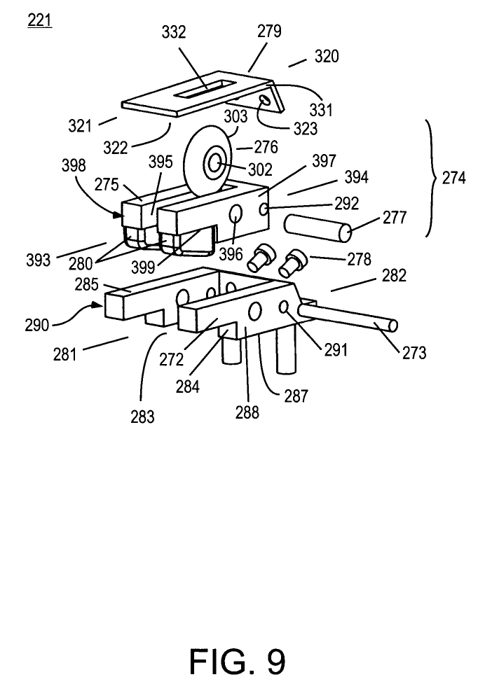

The upper jaw assembly 221, as illustrated in FIG. 9, includes the upper jaw 272, a pivot pin 273, a lever arm assembly 274, mounting screws 278, the upper docks 280, and at least one spring 279. The upper jaw 272 is rectangular in shape, and includes the first end 281, the second end 282, an upper surface 285, and a bottom surface 287. The first end 281 includes the cutout 283 that is slightly larger than a lever arm 275 of the lever arm assembly 274. The first end 281 further includes a recessed portion 284 that provides clearance for the insertion of a tube to be cut. The upper jaw 272 further includes a pivot aperture 291 that passes from a first side 288 to a second side 290. The pivot aperture 291 is of a size suitable to accommodate the pivot pin 273.

The second end 282 of the upper jaw 272 includes a recessed flat 293 with an angled face 294. The recessed flat 293 includes the threaded aperture 295, and at least one guide aperture 296 that passes from the recessed flat 293 through to the bottom surface 287. The threaded aperture 295 includes threads suitable for mating with the threads 262 of the threaded member 246. The guide aperture 296 is suitable for mating with the upper guide pin 248. The angled face 294 includes at least one mounting aperture 297 of a suitable size to accommodate the screw 278.

The springs 279 are in the shape of a sheet. A bend 331 is introduced into a primary plane of the springs 279, such that spring action is available in the secondary plane. The springs 279 include a first end 320, a second end 321, and apertures 323 for mounting screws 278. The second end 321 of the springs 279 are tapered to a width less than the width of the lever arm 275. The springs 279 further include a clearance aperture 332. The clearance aperture 332 allows a blade 276 to pass through the springs 279 during use.

The lever arm assembly 274 includes the lever arm 275, the cutter or blade 276, and a cutter shaft 277. The lever arm 275 is rectangular in shape, and of a size complementary to the cutout 283 of the upper jaw 272. The lever arm 275 includes a first end 393, a second end 394, a first side 397, and a second side 398. The first end 393 includes a cutout 395 and a recessed portion 399. The cutout 395 is of a width suitable for receiving the blade 276. The recessed portion 399 is complementary to the shape of an upper dock 280. In this preferred embodiment, there is an upper dock 280 on each remaining segment of the lever arm 275. The lever arm 275 further includes a shaft aperture 396 and a pivot aperture 292 that pass from the first side 297 through the entire lever arm 275 to the second side 398. The shaft aperture 396 is complementary in size to the cutter shaft 277. The pivot aperture 292 is of a size suitable for accepting the pivot pin 273.

The cutter shaft 277 is cylindrical in shape, and of a length not exceeding a total width of the lever arm 275. The diameter of the cutter shaft 277 is of a size suitable for entering a shaft aperture 302 of the blade 276. The shaft 277 may be constructed from any suitable material having adequate strength properties, preferably hardened steel. The blade 276 is circular in cross-section with a chamfered outer periphery 303 producing an acute angle. The shaft aperture 302 is located along the cylindrical axis of the blade 276, such that the blade may rotate about the shaft aperture.

The guide tube 224 is cylindrical in shape and includes an outer periphery 304, the inner periphery 305, and a cutout 306. The inner periphery 305 is of a diameter suitable for surrounding the remaining assembled cutter head assembly 120 components. The cutout 306 is of a similar size as the cutouts 183 and 283 in the right and left traction plates 117 and 118, respectively. The outer periphery 304 is of a size suitable for engaging the grooves 186 and 286 in the right and left traction plates 117 and 118. The guide tube 224 further includes mounting apertures 307 passing through the guide tube 224, suitable for clearance by the screws 253. The guide tube 224 still further includes gear teeth 308 disposed along the outer periphery 304 of the guide tube 224. The size and spacing of the gear teeth 308 are complementary to the size and spacing of the gear teeth of the first and second output gears 145 and 147.

The guide tube 224 further includes a window 309, a magnet aperture 348, and a size adjustment access aperture 313, as illustrated in FIG. 6. The window 309 provides a line of sight to visually align the blade 276 with a mark on a tube to be cut. In one embodiment, the magnet aperture 348 is located approximately 135 degrees around the guide tube from the center of the passage 119 such that the magnet aperture 348 aligns with the second switch 343 when the tubing cutter 100 is assembled and the cutter head assembly is in an aligned position for receiving a tube. The magnet aperture 348 is used to house a magnet 342. The adjustment aperture 313 allows an operator to insert a tool through the guide tube 224 during adjustment of the jaw span of the cutter head assembly 120.

A light assembly 340 is disposed within the tubing cutter 100 to aid the operator during use by illuminating the passage 119. FIG. 11 provides an electrical schematic for the lighting circuit. The light assembly 340 includes the light source 344, the magnet 342, the first switch 341, the second switch 343, and an activator switch 219. The light source 344 may be any form of lighting apparatus, preferably a light emitting diode (LED). The light source 344 is electrically connected to the first switch 341, such that when the first switch is held closed the light source is powered. First switch 341 may be a hold to close switch wherein the switch must be held in a depressed state to power the light source 344.

The activator switch 219 is a variable speed switch and is electrically connected to the power supply 130 and the driver 135 such that the driver 135 operates when the activator switch 219 is depressed. The normally closed second switch 343 is serially coupled to the normally open first switch 341. In the illustrated embodiment, the first switch serves as both a light switch to provide power to the light source 344 and an alignment switch for aligning the cutter head assembly.

The driver is activated when the first and second switches are closed. The second switch is configured to open when the cutter head assembly is rotated to an alignment position. In one embodiment, the second switch is magnetically sensitive and co-operates with a magnet coupled to the rotating cutter head assembly. In this embodiment, the magnet 342, as shown in FIG. 11A, is disposed within the magnet aperture 348 located in the guide tube 224 to be proximate the second switch 343 when the magnet is in the alignment position. The proximity of the magnet to the second switch opens the second switch so that the first switch is no longer capable of supply power to the driver 135. In one embodiment, the second switch 343 is a normally closed reed switch.

On assembly, the rollers 226 are aligned within the confines of the cutout 232 of the lower jaw 229, such that the central apertures of the rollers 226 are coaxial with the apertures 237 of the lower jaw 229. Once aligned, a roller shaft 227 may be inserted into each aperture 237 and through the central apertures of the rollers 226 to restrain the rollers 226 in position. The central apertures may be slightly larger than the diameter of the roller shaft 227 to allow the rollers 226 to rotate about the roller shafts 227. The lower dock 228 may then be positioned on the recessed portion 238, such that the width of the lower dock 228 is aligned with the width of the lower jaw 229, and the radius 240 is facing away from the lower jaw 229. The lower dock 228 may be fastened to the lower jaw 229 using any suitable means, including screws (not shown), adhesives, and the like.

Next, the upper guide pins 248 are pressed into the guide apertures 296 of the upper jaw 272. The upper guide pins 248 are permanently secured to the upper jaw 272, such that the upper guide pins 248 protrude through the bottom surface 287. Likewise, the lower guide pins 244 are pressed into the guide apertures 242 of the lower jaw 229. The lower guide pins 244 are permanently secured to the lower jaw 229, such that they protrude through the recessed flat 243. The threaded member 246 is then inserted into the central guide aperture 254 until the groove 259 of the threaded member 246 is aligned with the stake aperture 251, and the user interface 268 is nearest the bottom side 256 of the center block. Once aligned, the stake pins 247 are inserted into the stake apertures 251 to limit the movement of the threaded member 246 to rotation about the cylindrical axis. The stake pins 247 may be locked in place using any suitable means, including staking the openings of the stake apertures 251, or thread locking compounds.

Assembly of the lever arm assembly 274 follows with the placement of the blade 276 within the cutout 295 of the lever arm 275, such that the shaft aperture 302 is aligned with the shaft aperture 296. Once aligned, the shaft 277 may be inserted into the shaft apertures 302 and 296 to locate the blade 276 and limit movement of the blade 276 relative to the lever arm 275 to rotation about the shaft 277. Assembly of the lever arm assembly 274 further includes the installation of the upper dock 280 onto the recessed portion 399 of the lever arm 275. The upper dock 280 is installed such that a taper 311 points toward the first end 393 and away from the lever arm 275. The upper docks 280 may be installed using any suitable means, including screws, adhesives, and the like.

The upper jaw assembly 221 may be constructed after assembly of the lever arm assembly 274. The lever arm assembly 274 is inserted into the cutout 283 of the upper jaw 272, such that the recessed portion 399 of the lever arm 275 is aligned with the recessed portion 284 of the upper jaw 272, and the pivot aperture 292 of the lever arm 275 is aligned with the pivot aperture 291 of the upper jaw 272. Once aligned, the pivot pin 273 may be pressed into the pivot apertures 291 and 292 to restrict the movement of the lever arm assembly 274 to rotation about the pivot pin 273. Assembly of the upper jaw assembly 221 further includes aligning the mounting apertures 297 with the apertures 323, such that the interior surface 322 of the springs 279 is nearest the upper jaw 272. Once aligned, mounting screws 278 are installed to secure the first end 320 of the spring 279 to the upper jaw 272. The second end 321 of the spring 279 is then free to float along the first end 393 of the lever arm 275, thereby forcing the lever arm assembly 274 downward. With the spring 279 in the installed position, the lever arm assembly 274 is preloaded.

On further assembly, the upper jaw assembly 221 and the lower jaw assembly 222 are mated to the center block assembly 223. The threaded aperture 295 must be aligned with the first end 260 of the threaded member 246. Simultaneously, the threaded aperture 241 of the lower jaw assembly 222 must be aligned with the second end 261 of the threaded member 246. Each assembly should be aligned such that the lower dock 228 of the lower jaw assembly 222 and the upper dock 280 of the upper jaw assembly 221 are facing toward the center block 245. Once properly aligned, the threaded member 246 must be rotated to engage the threads 262 with the threaded aperture 295 in the upper jaw assembly 221, and the reverse threads 263 with the threaded aperture 241 of the lower jaw assembly 222. Once engaged, care must be taken to ensure that the guide pins 244 and 248 are properly aligned. As the assemblies 221 and 222 move closer together, the lower guide pins 244 are pressed into the guide apertures of the center block assembly 223, such that the bottom surface 256 of the center block 245 is nearest the lower jaw 229. The upper guide pins 248 then move into the inner diameters 258 of the lower guide pins 244. In this configuration, an increased span is available with a decreased head height. The lower and upper jaw assemblies 222 and 221 must be moved near to the center block assembly 223 to ease the installation of the assembled jaw section into the guide tube 224.

The assembled jaw section is placed within the inner periphery 305 of the guide tube 224, such that the mounting apertures 252 are aligned with the mounting apertures 307 of the guide tube 224. Once situated properly, the mounting screws 253 are installed to secure the jaw assembly to the guide tube 224. The magnet 342 is then inserted into the magnet aperture 348 and secured to the guide tube 224 using any suitable means, such as glue, screws, or the like, thereby forming the cutter head assembly 120.

In this preferred embodiment, assembly of the housing commences with pressing the bearings 188 into the right and left bearing plates 122 and 123. Each bearing plate 122 and 123 requires three bearings 188 to accept the shafts 150, 146, and 148 of the gears 145, 147, and 149. The right and left bearing plates 122 and 123 are then aligned with the right and left casings 111 and 112, such that the mounting apertures 167 and 267 align with the apertures 177 and 169 in the right and left casings 111 and 112, and the end with the drive gear aperture pairs 165 and 166, and the pair 265 and 266, is nearest the cutouts 174 and 175 of the casings 111 and 112. The right and left bearing plates 122 and 123 are then fastened to the right or left casing 111 or 112 using screws 317, respectively.

The light source 344 is inserted into the light aperture 345 of the left traction plate 118 and secured using any suitable means, such as gluing. The right traction plate 117 is aligned with the right casing 111, such that the cutout 183 is aligned with the cutout 174 of the right casing 111, the mounting apertures 189 are aligned with the mounting apertures 179 located in the right casing 111, and the groove 186 of the right traction plate 117 is facing toward the concave portion of the right casing 111. Once properly aligned, the right traction plate 117 is secured to the right casing 111 with mounting screws 317.

Next, the bearings 215 are inserted into the first and second bearing mounts 151 and 152. The bearing mounts 151 and 152 are then mounted onto the right casing 111, such that the input shaft 141 secured to the first bevel gear 143 may be inserted through the second bearing mount 152 and then through the first bearing mount 151. Once installed, the coupler 142 is installed onto the first end 153 of the input shaft 141. The drive gear assembly 201 is then inserted into the bearing 188 located in the drive gear shaft aperture 164, such that the second bevel gear 144 is in a lowest position. The input shaft 141 and the first bevel gear 143 are then maneuvered to engage the teeth 195 of the first bevel gear 143 with the teeth 199 of the second bevel gear 144. Once engaged, the driver 135 is installed into the casing 111, such that the driver 135 is restrained from rotating within the casing 111, and the output shaft 136 is secured to the coupler 142.

The first and second output gear assemblies 205 and 210 are then inserted into the bearings located in the apertures 165 and 166. Insertion of the output gear assemblies 205 and 210 is complete when the teeth 208 and 213 of the first and second output gears 145 and 147 engages the teeth 204 of the drive gear 149. Once fully inserted, the cutter head assembly 120 is located within the groove 186 of the traction plate 117 and the gear teeth 308 around the outer periphery 304 of the guide tube 224 are engaged with the gear teeth 208 and 213 of the first and second output gears 145 and 147.

The switches 341 and 343 are then inserted into the partially assembled tubing cutter 100 using any suitable means, preferably screws, snap features, or the like. Lastly, the activator switch 219 is installed. The left casing 112 is then installed onto the partially assembled device to further restrain the gear shafts 146, 148, and 150, further restrain the cutter head assembly 120, and to close out areas containing moving components. The upper ends of the gear shafts 146, 148, and 150 are positioned in the bearings 188 located in the apertures 264, 265, and 266. The exposed end of the guide tube 224 is situated in the groove 286 such that the cutter head assembly 120 can only rotate along the grooves 186 and 286. Once all components have been located properly, the left casing 112 is secured to the right casing 111 using the mounting screws 327.

In use, an operator must adjust the cutter head assembly jaw span to accommodate the diameter of the tube to be cut. FIG. 12 illustrates one embodiment of a method for adjusting the cutter head assembly jaw span.

In one embodiment, one end of the threaded member has been adapted with a user interface 268 to permit coupling to a tool for rotation. The method commences with step 1210, wherein the operator places a tool such as a screwdriver or Allen wrench into the adjustment aperture 313 in the guide tube 224 to engage the user interface 268 of the threaded member 246. Once engaged, the operator uses the tool to rotate the threaded member 246 clockwise or counter-clockwise as indicated in step 1220.

The rotation of the threaded member 246 and the complementary threads of the first and second ends of the threaded member force the engaged threads of the threaded apertures 295 and 241 in the upper jaw 272 and the lower jaw 229 to move axially along the threaded member 246. As the threaded member 246 is pinned at the midpoint, and the first and second threads 262 and 263 are of a like size and pitch, the upper and lower jaws 272 and 229 move about the pinned point and the center block 245 at a same rate and distance. In particular, the upper and lower jaws move relative to a common centerline that the pinned point lies on. The span of the jaws in the cutter head assembly is varied to accommodate the outer diameter of the tube being cut by rotating the threaded member in the appropriate direction.

In a closest position, the lower guide pins 244 extend into the center block 245, and the upper guide pins 248 into the inner diameter 258 of the lower guide pins 244. As the jaws move to a widest position, the lower guide pins 244 are able to move axially with the lower jaw 229, however, at least a portion of the lower guide pins 244 remains within the envelope of the center block 245 and around the outer diameter 257 of the upper guide pins 248. Likewise, the upper guide pins 248 move with the upper jaw 272, but remain partially inserted into the inner diameter 258 of the lower guide pins 244. As such, the upper and lower jaws 272 and 229 are free to move when the threaded member 246 is rotated. This configuration increases a maximum span dimension of the jaws based on the lengths of the guide pins 244 and 248. The reduced height requirement enables the cutter head assembly 120 and the tubing cutter 100 to have a smaller profile, thereby providing an increased accessibility.

Referring to step 1230, the threaded member is rotated until the desired jaw span is achieved. Once the desired jaw span is reached, the tool may be disengaged from the user interface in step 1240.

Alignment of the cutter head assembly 120 with the passage 119 may be accomplished using the alignment circuit. Referring to the method of FIG. 13 (and the circuit of FIG. 11), alignment commences with closing the normally open first switch 341 to provide power to the serially coupled, normally closed second switch 343. If the cutter head assembly is in an alignment position as indicated by step 1320, the second switch will be open as a result of the proximity of the magnet to the second switch. As previously discussed, the magnet is coupled to rotate with the cutter head assembly and is positioned to be proximate the magnetically sensitive second switch when the cutter head assembly is in the alignment position.

If the cutter head assembly is not in the alignment position, then the normally closed second switch permits power to flow to the driver in step 1330 and the cutter head assembly rotates until the magnet reaches the alignment position and opens the second switch. Once the cutter head assembly is aligned, the operator may open the first switch as indicated by step 1340.

The alignment operation is incorporated into the method of using the tubing cutter illustrated in FIG. 14. An operator prepares for a cutting operation by aligning the cutter head assembly 120 with the passage 119 of the tubing cutter 100, as shown in step 1410. The jaw span between the first and second jaws of the cutter head assembly is adjusted to accommodate the diameter of the tube to be cut in step 1420.

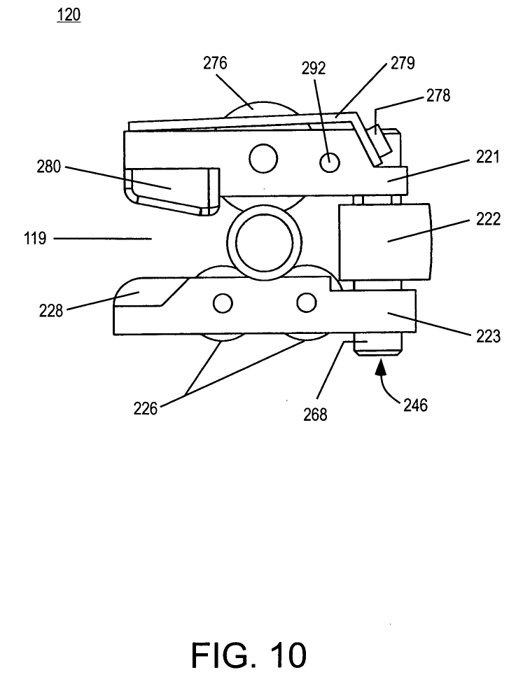

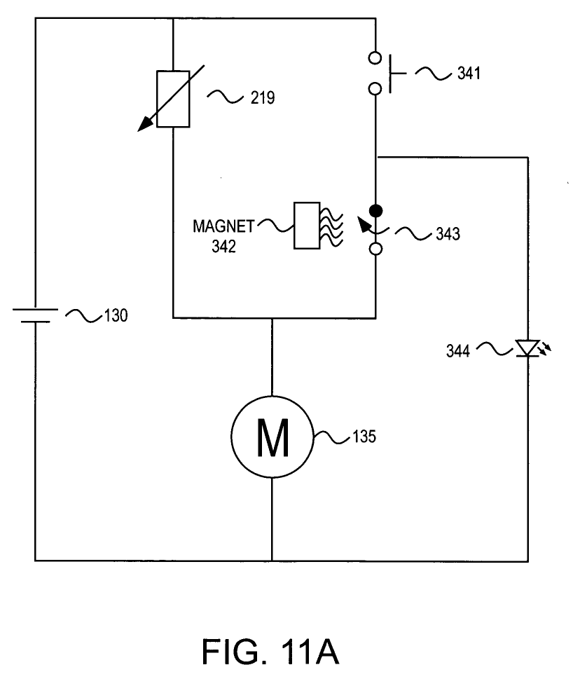

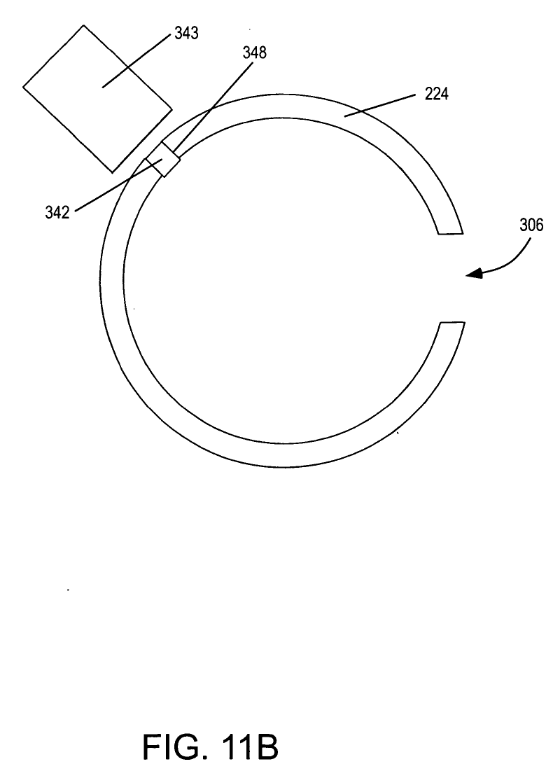

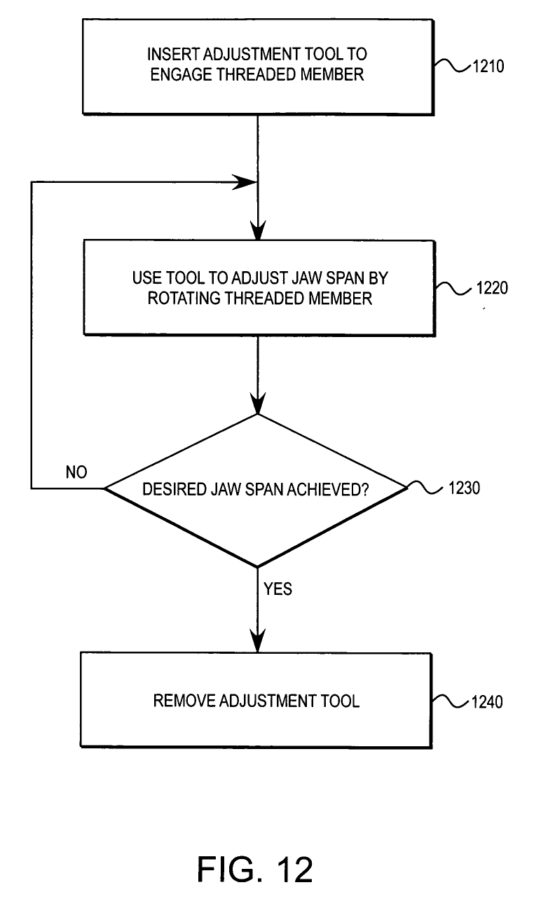

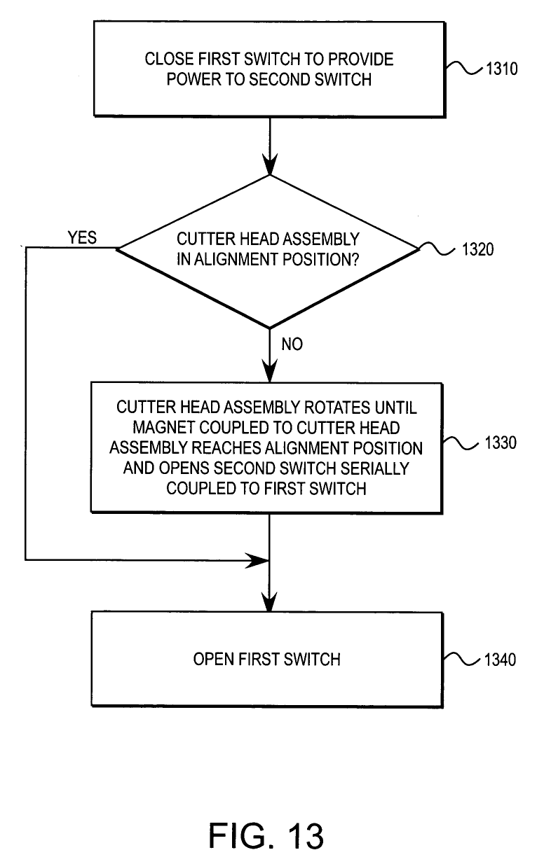

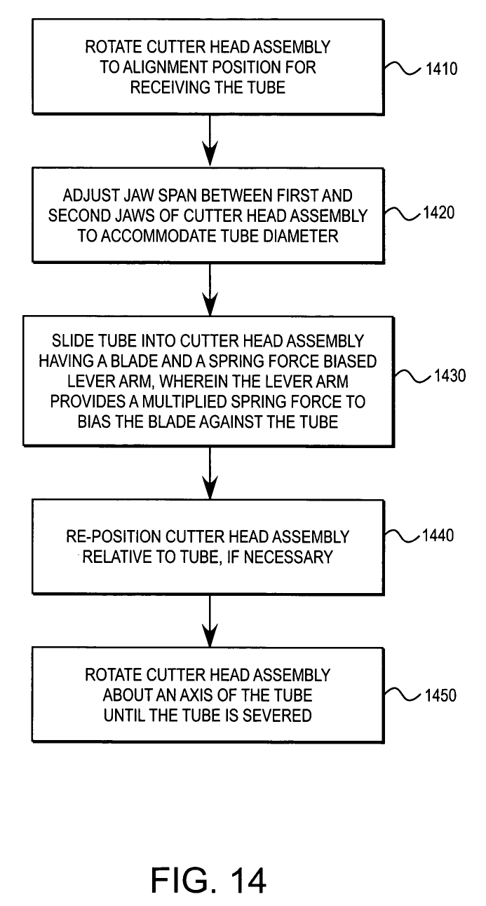

The operator slides the tube into the cutter head assembly in step 1430. Referring to FIG. 10, the tube enters the passage 119, and contacts the tapered or radius surfaces 240 of the upper docks 280 and the lower dock 228. The cutter head assembly has a blade and a spring force biased lever arm that provides a multiplied spring force to bias the blade against the tube. The tube is forced between the upper and lower docks 280 and 228 by the tapered or radius surfaces 240. Continued movement of the tube into the passage 119 forces the upper docks 280 and the attached lever arm 275 to swing upward about the pivot shaft 273. The slight angle of the lower dock 228 and the radius of the upper dock 280 allow the tube to move toward the center block 245 with minimal force.

The lever arm 275 continues to move upward as the tube moves further along the passage, thereby further deflecting the spring 279. Once the axial tube center passes upper and lower docks 280 and 228, the tube reaches an over-center condition that aids in the continued entry of the tube. In particular, the upper dock applies pressure to a remaining portion of the tube to further push the tube into the jaws. As the tube eases off of the upper and lower docks 280 and 228, it moves over a roller 226 to a detent position, thereby supporting the tube between both rollers 226 and the blade 276. The tube will remains in the detent position until the end of the cutting operation, or until removed by the operator. In this position, the lever arm 275 is pressured by the spring 279, and the tubing cutter is ready for the cutting operation.

The operator may verify that the location of the blade 276 by viewing the region of the tube including the blade contact area through the window 309. If necessary, the operator may illuminate the blade contact area by depressing first switch 341. Referring to step 1440, the operator may re-position the cutter head assembly relative to the tube prior to commencing the cutting operation, if necessary.

The cutter head assembly is then rotated about an axis of the tube in step 1450 until the tube is severed. Rotation of the cutter head assembly 120 moves the blade 276 around the outer periphery of the tube being cut. Lever arm 275 multiplies the spring force provided by spring 279 for biasing the blade against the tubing at the blade contact area. The blade displaces tube material as the blade 276 moves around the outer periphery of the tube. The bias provided by the spring force continues to advance the blade toward the interior of the tube until the tube is severed. Rotation is accomplished by depressing activator switch 219 to deliver power to the driver 135. The tubing cutter may be removed after the tube has been severed.

Although the present invention has been described in terms of the foregoing preferred embodiment, such description has been for exemplary purposes only and, as will be apparent to those of ordinary skill in the art, many alternatives, equivalents, and variations of varying degrees will fall within the scope of the present invention. That scope, accordingly, is not to be limited in any respect by the foregoing detailed description; rather, it is defined only by the claims that follow.

What is claimed is:

1. A cutter head assembly apparatus, comprising:
a first jaw;
a second jaw, wherein the first and second jaws are coupled to permit adjusting a span between the first and second jaws;
a blade;
a lever arm pivotably coupled to the first jaw, the lever arm carrying the blade; and
a spring applying a spring force to the lever arm to bias the blade towards the second jaw.

2. The apparatus of claim 1, wherein the lever arm applies a multiplied spring force to the blade.

3. The apparatus of claim 1, wherein the lever arm is positioned to increase the spring force when displaced by a tube placed between the first and second jaws.

4. The apparatus of claim 3, wherein the spring moves independently from the lever arm.

5. The apparatus of claim 1, wherein the first and second jaws move about a common centerline to adapt to varying tube diameters.

6. The apparatus of claim 3, wherein the apparatus is rotated about the tube to displace tube wall material at a blade contact point.

7. The apparatus of claim 1 wherein the pivotable lever arm co-operates with the spring to form a second class lever applying a force at the blade.

8. The apparatus of claim 1, further comprising:
a first guide pin coupled to the first jaw; and
a second guide pin coupled to the second jaw, wherein one of the first and second guide pins is adapted to receive the other of the first and second guide pins to permit relative longitudinal translation during span adjustment.

9. The apparatus of claim 8, further comprising:
a threaded member having a first end with a first thread direction and a second end with an opposing second thread direction, wherein the first end is threadably coupled to the first jaw and the second end is threadably coupled to the second jaw to permit increasing or decreasing the span in accordance with a rotation of the threaded member.

10. The apparatus of claim 1 wherein the blade is a rotatable cutter.

11. A tubing cutter apparatus, comprising
a housing including a passage for receiving a tube;
a cutter head assembly disposed within the housing and around the passage, the cutter head assembly including a blade and a spring force biased lever arm, wherein the lever arm provides a multiplied spring force to bias the blade; and
a driver coupled to rotate the cutter head assembly around the tube.

12. The apparatus of claim 11, further comprising:
a plurality of rollers, wherein the biased blade co-operates with the rollers to retain the tube in a detent position between the rollers.

13. The apparatus of claim 11, further comprising:
a guide tube coupled to the cutter head assembly, wherein the driver engages the guide tube to rotate the guide tube and the cutter head assembly about a tube axis.

14. The apparatus of claim 13, wherein the guide tube includes a cutout for viewing a point of contact of the blade on the tube.

15. The apparatus of claim 11, further comprising:
a light source disposed to illuminate a blade contact area.

16. The apparatus of claim 15, wherein the light source is a light emitting diode.

17. The apparatus of claim 11, further comprising:
an alignment circuit that rotates the cutter head assembly to an aligned position for receiving the tube when activated.

18. The apparatus of claim 17, wherein the alignment circuit comprises:
a normally open first switch for providing power to the driver; and
a normally closed second switch series-coupled to the first switch, wherein the second switch permits application of power to the driver through the first switch only when the cutter head assembly is not in the aligned position.

19. The apparatus of claim 18, wherein the second switch is a reed switch activated by a magnet coupled to rotate with the cutter head assembly.

20. The apparatus of claim 11, further comprising:
a first guide pin coupled to a first jaw of the cutter head assembly; and
a second guide pin coupled to a second jaw of the cutter head assembly, wherein one of the first and second guide pins is adapted to receive the other of the first and second guide pins to permit relative longitudinal translation during a span adjustment between the first and second jaws.

21. The apparatus of claim 20, further comprising:
a threaded member having a first end with a first thread direction and a second end with an opposing second thread direction, wherein the first end is threadably coupled to the first jaw and the second end is threadably coupled to the second jaw to permit increasing or decreasing the span in accordance with a rotation of the threaded member.

22. The apparatus of claim 21, wherein the first and second jaws move at the same rate and distance relative to a common centerline when the threaded member is rotated.

23. The apparatus of claim 22, further comprising:
a center block providing an axial restraint point for restraining the threaded member from axial movement relative to the center block, wherein the axial restraint point lies on the common centerline.

24. The apparatus of claim 23, wherein the center block has guide apertures for receiving the first and second guide pins, wherein the guide apertures provide alignment support for relative longitudinal translation of the first and second guide pins.

25. The apparatus of claim 21, wherein at least one of the first and second ends of the threaded member is adapted for coupling to a tool for rotation.

26. A method of cutting a tube, comprising:
a. sliding a tube into a cutter head assembly having a blade and a spring force biased lever arm, wherein the lever arm provides a multiplied spring force to bias the blade against the tube; and
b. rotating the cutter head assembly about an axis of the tube, wherein the blade displaces tube material until the tube is severed.

27. The method of claim 26 comprising:
c. rotating the cutter head assembly to an alignment position for receiving the tube.

28. The method of claim 26 comprising:
c. adjusting a jaw span between a first jaw and a second jaw of the cutter head assembly to accommodate a diameter of the tube.

29. The method of claim 28 wherein adjusting a jaw span comprises rotating a threaded member having a first end with a first thread direction and a second end with an opposing second thread direction, wherein the first end is threadably coupled to the first jaw, wherein the second end is threadably coupled to the second jaw, wherein the jaw span varies in accordance with a rotation of the threaded member.
